(19) United States
(12) Patent Application Publication
(10) Pub. No.: US 2014/0297190 A1
(43) Pub. Date: Oct. 2, 2014

(54) MONITORING OF SOURCE SIGNATURE DIRECTIVITY IN SEISMIC SYSTEMS

(71) Applicant: CGG Services SA, Massy Cedex (FR)

(72) Inventors: Julie SVAY, Guyancourt (FR); Yuan NI, Antony (FR); Cheikh NIANG, Saint Cyr L'Ecole (FR)

(73) Assignee: CGG Services SA, Massy Cedex (FR)

(21) Appl. No.: 14/200,223

(22) Filed: Mar. 7, 2014

Related U.S. Application Data
(60) Provisional application No. 61/805,271, filed on Mar. 26, 2013.

(51) Int. Cl. G01V 13/00; G01V 1/30

(52) U.S. Cl. CPC G01V 13/00; G01V 1/30
USPC 702/16

(57) ABSTRACT

Methods and systems for generating a stability indicator associated with source directivity between shots and based on a signature are described. The stability indicator is computed by comparing a reference directivity cube to a source directivity cube using a partitioned intensity uniformity (PIU) metric. In another aspect, the stability indicator can be normalized to produce a scalar stability indicator expressed in percentage.

### RELATED APPLICATION

The present application is related to, and claims priority from U.S. Provisional Patent Application No. 61/805,271, filed Mar. 26, 2013, entitled “MONITORING OF SOURCE SIGNATURE DIRECTIVITY,” to Julie SVAY, Yaun NI, and Cheikh NIANG, the disclosure of which is incorporated herein by reference.

### TECHNICAL FIELD

Embodiments of the subject matter disclosed herein generally relate to methods and systems for seismic data processing and, more particularly, to mechanisms and techniques for determining a fault, e.g., a delay or an air leak in an air gun, of individual pressure wave sources of a marine source array based on near-field data acquired by pressure sensors placed near each of the individual pressure wave sources.

### BACKGROUND

Seismic data acquisition and processing techniques are used to generate a profile (image) of a geophysical structure (subsurface) of the strata underlying the land surface or seafloor. Among other things, seismic data acquisition involves the generation of acoustic waves and the collection of reflected/refracted versions of those acoustic waves to generate the image. This image does not necessarily provide an accurate location for oil and gas reservoirs, but it may suggest, to those trained in the field, the presence or absence of oil and/or gas reservoirs. Thus, techniques associated with providing an improved image of the subsurface in a shorter period of time is an ongoing research topic in the field of seismic surveying.

As part of the process of generating such images, e.g., based on seismic trace data the collection of which is described in more detail below, and the fact that offshore drilling is an expensive process, those undertaking it need to know where to drill in order to avoid a dry well. During a seismic survey, a vessel tows a seismic wave source and detectors (wave receivers) located on streamers. Reflections of the source-generated waves are recorded by the detectors. The waves are reflected interfaces between layers, when the density and the wave velocity change, e.g., at an interface between water and air, water to rock, shale to sand, etc.

A popular seismic wave source is the air gun. An air gun stores compressed air and releases it suddenly underwater when fired. The released air forms a bubble, which can be considered spherical, with air pressure inside the bubble initially greatly exceeding the hydrostatic pressure in the surrounding water. The bubble expands, displacing the water and causing a pressure disturbance that travels through the water. As the bubble expands, the pressure decreases, eventually becoming lower than the hydrostatic pressure. When the pressure becomes lower than the hydrostatic pressure, the bubble begins to contract until the pressure inside again becomes larger than the hydrostatic pressure. The process of expansion and contraction may continue through many cycles, thereby generating a pressure, i.e., seismic, wave.

The pressure variation generated in the water by an air gun, which can be measured as a function of time using a hydrophone or geophone located near the air gun, is called the air gun signature an example of which is illustrated in FIG. 1. A first pressure increase due to the released air is called the primary pulse and it is followed by a pressure drop known as a ghost. Between highest primary pressure and lowest ghost pressure there is a peak pressure variation (P-P). The pulses following the primary and the ghost are known as a bubble pulse train. The pressure difference between the second pair of high and low pressures is a bubble pressure variation Pb-Pb. The time T between pulses is the bubble period. A parameter evaluated based on the signature is the peak-to-bubble ratio, which is P-P/Pb-Pb.

Single air guns are typically not practical as the sole source of seismic waves because they do not produce enough energy to penetrate at desired depths under the seafloor, and a plurality of weak oscillations, i.e., the bubble pulse train, following the primary (first) pulse complicates seismic data processing. These problems can be overcome by using arrays of air guns, generating a larger amplitude primary pulse and canceling secondary individual pulses by destructive interference.

FIG. 1 represents a situation in which the bubble generated by a single air gun drifts slowly toward the surface, surrounded by water having the hydrostatic pressure constant or slowly varying as the bubble slowly drifts upward. However, when another air gun is fired simultaneously in proximity to the first air gun, the hydrostatic pressure is no longer constant or slowly varying, i.e., the bubbles of neighboring guns affect each other.

A source array includes a plurality of individual wave sources. An individual wave source may be an air gun or a cluster of air guns. Since the dimensions of the source array, including the plurality of individual sources, are comparable with the wavelengths of a generated wave, the wave generated by the source array is directional, i.e., the shape of the wave, or the signature varies with the direction until, at a great enough distance, the wave starts having a stable shape. After the shape becomes stable, the amplitude of the wave decreases inversely proportional to the distance from the source. The region where the signature shape no longer changes significantly with distance is known as the “far-field,” in contrast to the “near-field” region where the shape varies based on the distance from the source. Knowledge of the wave source's far-field signature is desirable in order to extract information about the geological structure generating the detected wave upon receiving the far-field input wave.

In order to estimate the source array's far-field signature, an equivalent notional signature for each individual source may be calculated for each of the guns using near-field measurements (see e.g., U.S. Pat. No. 4,476,553 incorporated herein by reference). The equivalent notional signature is a representation of the amplitude of the wave due to an individual wave source as a function of time, the source array's far-field signature being a superposition of the notional signatures corresponding to each of the individual sources. In other words, the equivalent notional signature is a tool for representing the contribution of an individual source to the far-field signature, such that the individual source contribution is decoupled from contributions of other individual wave sources in the source array.

However, the stability and reliability of the far-field signature depends on the stability of each of the individual wave sources and of the source array's geometry. During a seismic survey, the individual wave sources' behavior may change, e.g., firing later or earlier than expected or at a smaller amplitude than nominally designed, and therefore affect the far-field source signature.

Accordingly, it would be desirable to have methods and apparatuses capable of identifying faults of individual wave sources of a marine source array in order to enable the operator to make an informed decision or implement corrective actions during a marine seismic survey.

### SUMMARY

According to various embodiments described herein, methods and systems identify faults of individual wave sources of a marine source array by, for example, computing current and reference directivity cubes associated with each source's shot. The current and reference directivity cubes are processed as images and then compared with each other to generate information regarding the stability of the source.

According to an embodiment, a method for monitoring the stability of source directivity between shots, based on an image registration metric of a source signature and generating a stability indicator includes the steps of computing a current source directivity cube, selecting a portion of the current source directivity cube for analysis, computing a reference directivity cube within the portion, computing a partitioned intensity uniformity (PIU) metric based on the reference directivity cube and the portion of the source directivity cube, using the PIU metric to generate the stability indicator; and outputting the stability indicator.

According to another embodiment, a method for generating a stability indicator includes the steps of computing a source directivity cube and a reference directivity cube, computing a partitioned intensity uniformity (PIU) metric using at least a portion of the source directivity cube and the reference directivity cube, using said PIU metric to generate the stability indicator; and outputting the stability indicator.

According to another embodiment, a system for generating a stability indicator based on an image registration metric of a source signature associated with seismic data includes seismic data, one or more processors configured to execute computer instructions and a memory configured to store the computer instructions wherein the computer instructions further comprise: a cube component for generating directivity cubes, a partitioned intensity uniformity component for generating a PIU metric based on the directivity cubes, a stability indicator component for comparing the PIU metric to a predetermined threshold value and generating a stability indicator; and an output component for outputting the stability indicator.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts a graph illustrating pressure variation with time when a gun fires which represents a source signature;

FIG. 2 shows various aspects of an exemplary marine seismic survey system in which various source stability embodiments can be implemented;

FIGS. 3A and 3B depict two cross-sections of radiation patterns which can be compared with a single scalar image registration metric according to an embodiment;

FIGS. 4-5 depict flowcharts of method embodiments;

FIG. 6 shows various aspects of software components or modules which can be used to implement the embodiments; and

FIG. 7 illustrates an exemplary data processing device or system which can be used to implement the embodiments.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of generating maps of seismic illumination during marine acquisition. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to various embodiments described herein, methods and systems identify faults of individual wave sources of a marine source array by, for example, computing current and reference directivity cubes associated with each source's shot. The current and reference directivity cubes are processed as images and then compared with each other to generate information regarding the stability of the source. Such methods and systems can be used, for example, in the quality control of the data acquisition and to help guide the performers of seismic surveys to make infill decisions during the surveys.

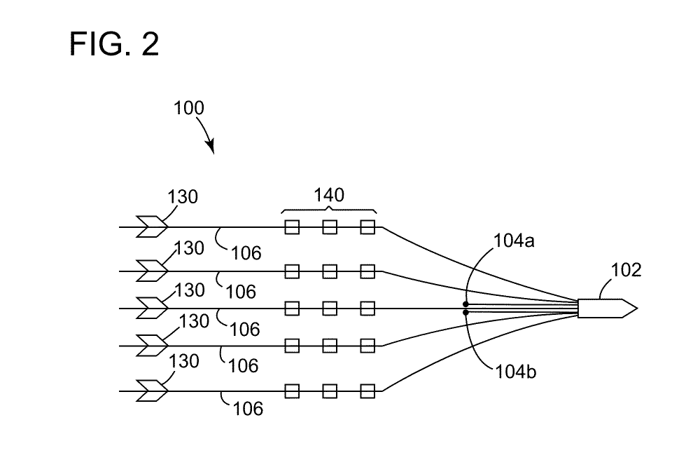

In order to provide some context for the subsequent exemplary embodiments related to positioning sensitivity indication, consider first a seismic data acquisition process and system as will now be described with respect to FIG. 2. In FIG. 2, a data acquisition system 100 includes a ship 102 towing plural streamers 106 that may extend over kilometers behind ship 102. Each of the streamers 106 can include one or more birds 130 that maintains streamer 106 in a known fixed position relative to other streamers 106, and the birds 130 are capable of moving streamer 106 as desired according to bi-directional communications birds 130 can receive from ship 102.

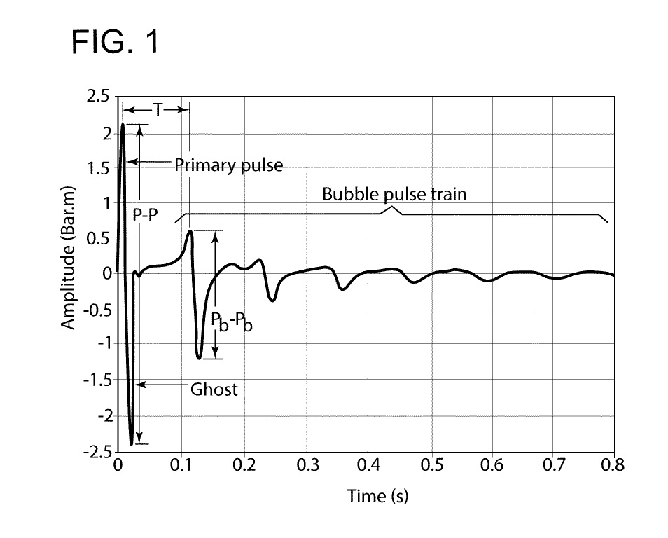

One or more source arrays 104a,b may be also towed by ship 102 or another ship (not shown) for generating seismic waves. Source arrays 104a,b can be placed either in front of or behind receivers 140, or both behind and in front of receivers 140. The seismic waves generated by source arrays 104a,b propagate downward, reflect off of, and penetrate the seafloor, wherein the refracted waves eventually are reflected by one or more reflecting structures (not shown in FIG. 1) back to the surface. The reflected seismic waves propagate upwardly and are detected by receivers 140 provided on streamers 106. This process is generally referred to as “shooting” a particular seafloor area, and the seafloor area can be referred to as a “cell,” or geographical area of interest (GAD.

The signals recorded by seismic receivers 140 vary in time, having energy peaks that may correspond to reflectors between layers. In reality, since the sea floor and the air/water are highly reflective, some of the peaks correspond to multiple reflections or spurious reflections that should be eliminated before the geophysical structure can be correctly imaged. Primary waves suffer only one reflection from an interface between layers of the subsurface.

With this context in mind, the data collected by receivers 140 can be processed to, among other things, monitor the far-field signature for the stability of the source directivity from shot to shot based on an image registration metric as will be described subsequently according to embodiments described below. Reference and current directivity cubes are processed, on a shot by shot basis, and processed for comparison as images. The difference in the images provides information regarding the stability of the source, which can be output as an indicator. Such embodiments are now discussed in more detail.

Far field signatures associated with air guns (sources) are generally described above. Consider further that the radiation pattern associated with a far-field signature, describes its amplitude directivity “A” as a function of the frequency “ω,” and an observation direction, defined in this example relative to the source position by two Euler angles “θ, φ.”, e.g., a cross-line incidence angle and an azimuth angle. Accordingly, the directivity is a three-dimensional data cube defined as A(ω, θ, φ). Among other parameters, the source signature and the associated directivity are typically corrected for during seismic data processing in order to free the seismic image from dependence on the incidence angle and to restore true amplitudes. However the embodiments described herein enable the usage of the directivity parameter to also determine or estimate the source's stability.

Accordingly, the generation of the full reference data cube and the full current data cube can be performed in a manner known to those skilled in the art and, therefore, is not discussed in detail here. Any of a number of different techniques can be used to perform this step including, but not limited to, (1) using the real gun situations (i.e., the measured position of the air gun when it is fired and its actual output pressure) and then numerically simulate the signature directivity; (2) using the acquired near-field (NF) data to inverse the position of guns with a better resolution, and then use the method described in U.S. patent application Ser. No. 13/766,157, filed on Feb. 13, 2013, and entitled “Method for Detecting Air Gun in Marine Array, the disclosure of which is incorporated herein by reference, to reconstruct the source directivity, (3) using the far field (FF) carpet to measure the source directivity; and/or (4) using the acquired seismic data itself to inverse the source directivity. Any other methods can also be used to calculate the full directivity diagram of the source.

The full current directivity cube is determined based on the information gathered from the current shot. The full reference directivity cube can be generated using any desired, comparable shot information that is representative of the expected radiation pattern of the source, e.g., based on one or more previous shots or, for 4D surveys, based on the corresponding shot in the baseline survey. The reference directivity cube can be fixed prior to the survey or can be variably determined during the survey.

According to some embodiments, it may not be necessary to compare the full reference directivity cube with the full current directivity cube. Instead, only a portion of interest of each cube can be processed. For example, it could be decided to focus the monitoring on the portions of each cube A(ω, θ, φ) where ω is a range of frequencies between 1 and 200 Hz, θ is a range of angles between −30° and +30°, and φ is a range of azimuth angles between 0 and 90°. Alternatively, the portions of interest in the directivity cubes could also be restricted to several specific two-dimensional cross-sections. As will be appreciated by those skilled in the art, the choice of which portion(s) of the directivity cubes to use in these embodiments will depend on the survey being performed. For example, for a typical seismic survey, the acquisition team may be most interested in the source signature to the back of the survey vessel, so only the semi-sphere of the directivity cubes associated with the region to the back of the vessel may be used. Alternatively, for a broad band survey it may be desirable to take into account the full band up to 200 Hz or higher, while for a narrow band survey it may be desirable to take into account only the portions of the cubes from 1 Hz-70 Hz. For an undershoot survey it may be desirable to take into account only the side (port or starboard) with the streamers. Those skilled in the art will appreciate that these are just examples and that there may be other reasons to select one or more portions of interest in the reference cube and the current cube to compare for indicators of source stability as described below.

After the full directivity cubes are generated, and the desired portion(s) thereof are extracted as discussed above, the stability, (or, reciprocally, the variability) of the current directivity cube A (or portion(s) thereof) with respect to the reference directivity cube A_{ref}(ω, θ, φ) is evaluated. More specifically, a stability indicator is defined by processing the two directivity cubes (or portion(s) thereof) as images, i.e., pixels, at observation coordinates x(ω, θ, φ), with different intensities, i.e., amplitudes “A” in decibels (dB) and then the pixels of each are compared to one another. According to one embodiment, the pixels associated with the current directivity cube and the pixels associated with the reference directivity cube are compared with an adapted Partitioned Intensity Uniformity (PIU) metric.

To do this, the pixels associated with the reference directivity cube are partitioned into iso-intensity sets b and then mapped to the current imprint. Continuing with the embodiment, the PIU metric is then defined as:

$$P I U ( reference , current ) = {\sum }_{b} \frac{{n}_{b}}{N} \frac{{σ}_{b} ( current )}{{μ}_{b} ( current )} \qquad ( 1 )$$

where N is the total number of pixels in the cube portion, n_{b} is the number of reference pixels within the iso-intensity set b, μ_{b} and σ_{b} are the mean and standard deviation measured on the current directivity cube within each mapping b^{T} of set b, represented by the equations:

$$\begin{matrix}{μ}_{b} ( current ) = \frac{1}{{n}_{b}} {\sum }_{x ∈ {b}^{T}} A ( x ) \\ and & ( 2 ) \\ {σ}_{b}^{2} ( current ) = \frac{1}{{n}_{b}} {\sum }_{x ∈ {b}^{T}} {( {A}_{current} ( x ) - {μ}_{b} ( current ) )}^{2} . & ( 3 )\end{matrix}$$

The thus calculated source stability metric, i.e., PIU(reference, current), can be normalized to obtain a normalized scalar stability indicator, e.g., expressed as a percentage. It should be noted in the embodiment that the normalized metric provides a user-friendly scalar indicator comprising features to qualify, rank and monitor the variations occurring within two three-dimensional directivity sets.

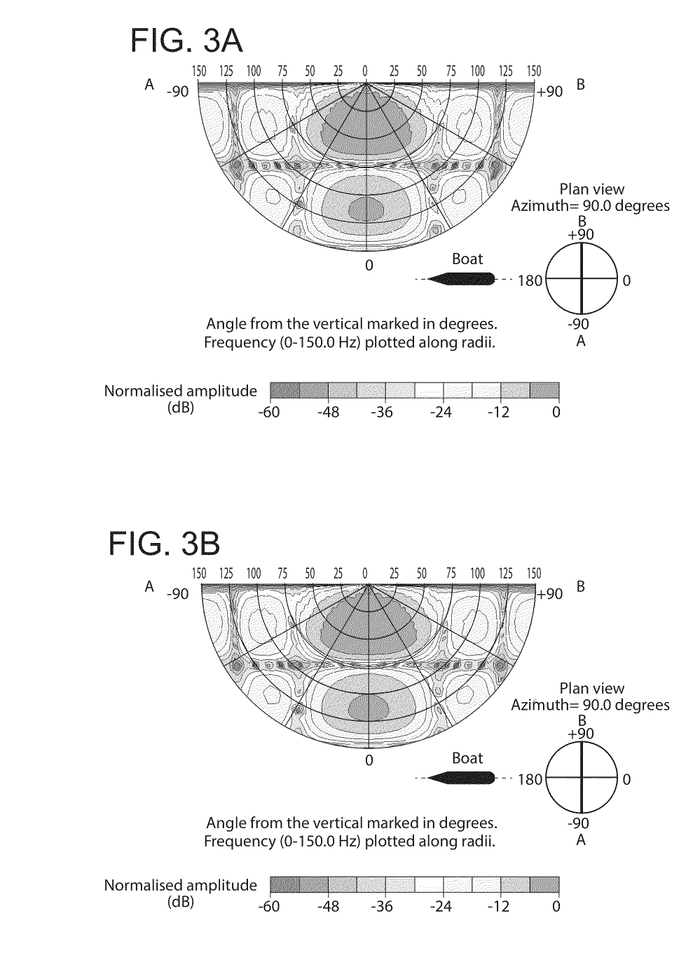

As a purely illustrative example, two cross-sections of radiation patterns associated with source directivity were processed as images (pixels) and are depicted in FIGS. 3A and 3B. Variations in intensity, i.e., amplitude, are seen in the patterns as differences in grey-scale (as shown) or color (not shown) which can be scaled. Using, for example, the afore-described calculations, these two radiation patterns (one corresponding to the reference pattern, e.g., that of FIG. 3A, and one corresponding to the current pattern (e.g., that of FIG. 3B, were evaluated and a similarity indicator of 95% was generated and output by the system.

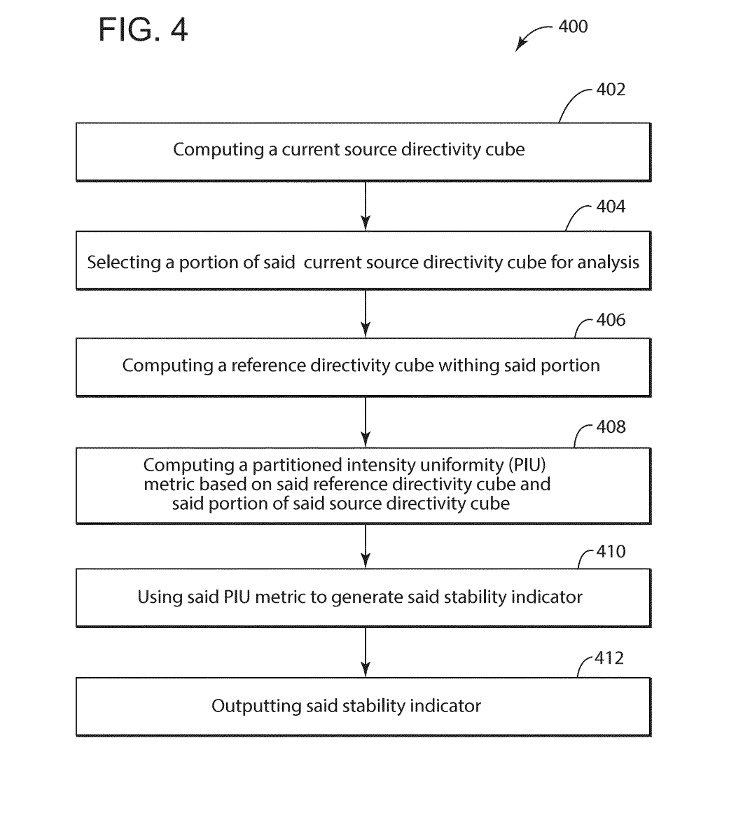

It will be appreciated by those skilled in the art that such techniques can, for example, be expressed as method embodiments for monitoring the stability of source directivity between shots. For example, turning now to FIG. 4, a method embodiment 400 for monitoring the stability of source directivity between shots and generating a stability indicator is depicted. In accordance with the foregoing discussion, the stability indicator used in the method 400 is based on an image registration metric of a far-field source signature. Starting at step 402 of the method embodiment 400, a current source directivity cube is computed.

Next, at step 404 of the method embodiment 400, a portion of the current source directivity cube is selected for analysis. Continuing at step 406 of the method embodiment, a reference directivity cube within the selected portion is computed. Next at step 408 of the method embodiment, a partitioned intensity uniformity (PIU) metric is computed. It should be noted in the method embodiment 400 that the PIU is based on the portion(s) of the reference directivity cube which correspond to the selected portion(s) of the source directivity cube.

Continuing at step 410, the computed PIU metric is used to generate a stability indicator. This step can involve simply taking the computed PIU metric as the stability indicator. Alternatively, some additional processing can be performed on the PIU metric to generate the stability indicator. For example, the PIU metric can be normalized to generate a scalar value such as a percentage. Next at step 412, the generated stability indicator is output for further processing. For example, the metric can be used for each survey line to perform quality control on any detected anomalies in the source's directivity.

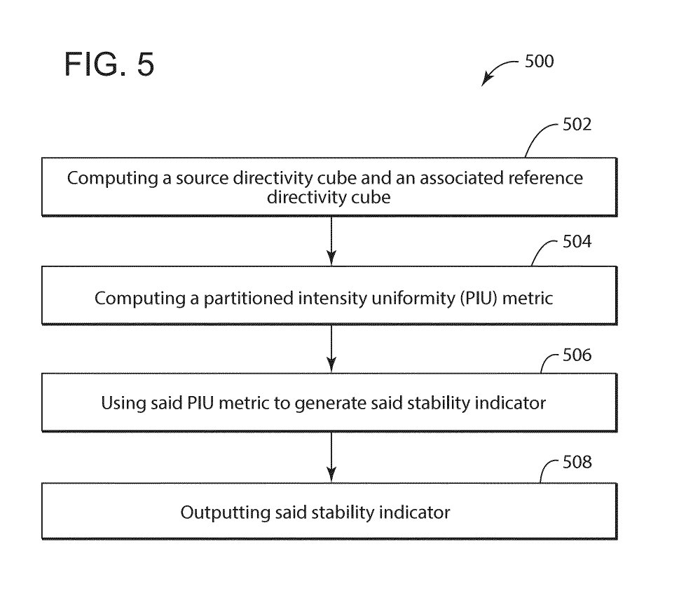

Of course the methodology according to embodiments can also be expressed more generally. For example, looking now to FIG. 5, a method embodiment 500 for generating a stability indicator is depicted. As with the previous embodiment, in the method 500 the stability indicator is also based on an image registration metric of a far-field source signature. Starting at step 502, a current source directivity cube and a reference directivity cube are computed. Next at step 504 of the method embodiment, a partitioned intensity uniformity (PIU) metric is computed.

Continuing at step 506, the computed PIU metric is used to generate a stability indicator. Next at step 508, the generated stability indicator is output.

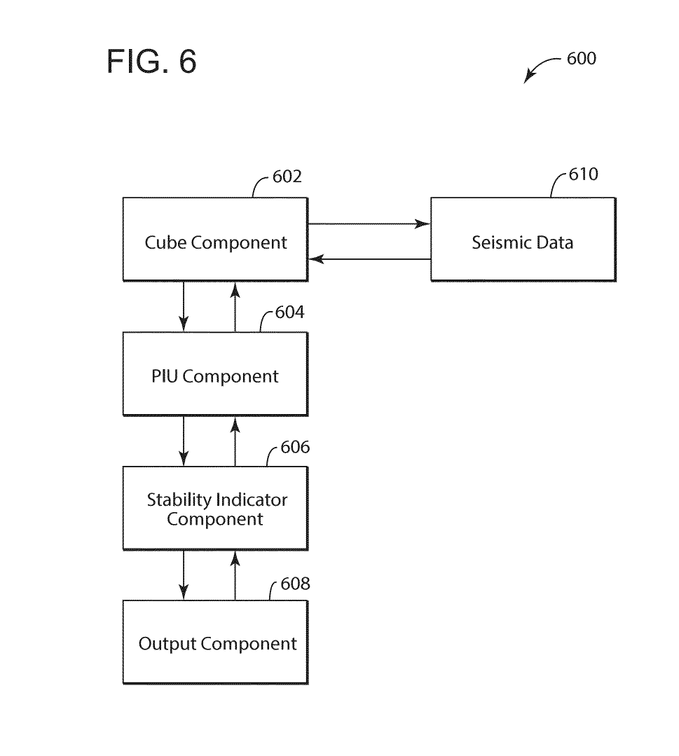

As will be appreciated from the foregoing discussion, methods for generating a stability indicator according to these embodiments can, at least in part, be implemented in software operating on a suitably programmed computing device. A system embodiment, with suitable software modules or components, will now be described with respect to FIG. 6. The software modules include a cube component 602, a partitioned intensity uniformity (PIU) component 604, a stability indicator generation component 606, an output component 608 and seismic data 610. The cube component 602 provides the capability to generate directivity cubes based on the seismic data 610 or using other techniques as mentioned above.

Continuing with the system 600, the PIU component 604 provides the capability to generate a PIU metric based on the directivity cubes. Next in the embodiment node 600, the stability indicator generation component 606 provides the capability to generate a stability indicator using the PIU metric. Continuing with the embodiment node 600, the output component 608 provides the capability to output stability indicators for further processing. It should be noted in the system 600 that the stability indicators can be delivered locally, i.e., onboard the seismic vessel or to a remote location, i.e., land based, for analysis and decision making.

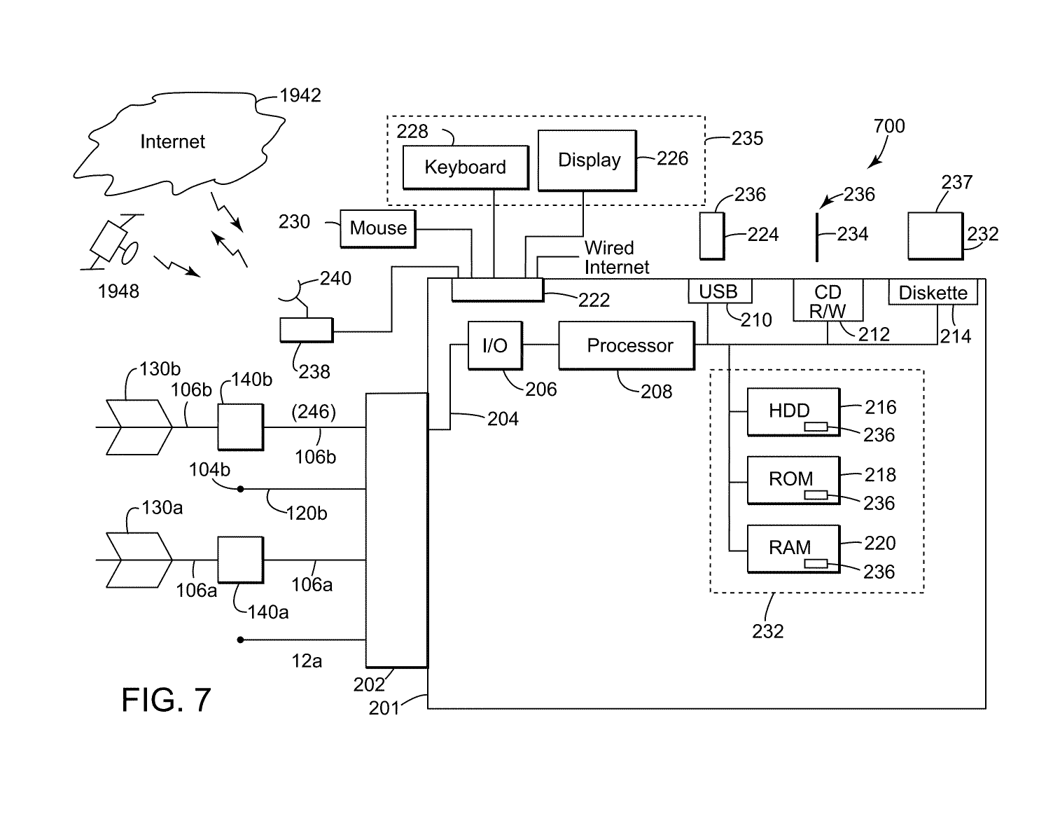

Such software modules can be implemented using computing device(s) or other network nodes involved in generating a stability indicator, as set forth in the above described embodiments, which can be any type of computing device capable of processing and communicating seismic data associated with a seismic survey. An example of a representative computing system capable of carrying out operations in accordance with these embodiments is illustrated in FIG. 7. System 700 includes, among other items, server 201, source/receiver interface 202, internal data/communications bus (bus) 204, processor(s) 208 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 210, compact disk (CD)/digital video disk (DVD) read/write (R/W) drive 212, floppy diskette drive 214 (though less used currently, many servers still include this device), and data storage unit 232.

Data storage unit 232 itself can comprise hard disk drive (HDD) 216 (these can include conventional magnetic storage media, but, as is becoming increasingly more prevalent, can include flash drive-type mass storage devices 224, among other types), ROM device(s) 218 (these can include electrically erasable (EE) programmable ROM (EEPROM) devices, ultra-violet erasable PROM devices (UVPROMs), among other types), and random access memory (RAM) devices 220. Usable with USB port 210 is flash drive device 224, and usable with CD/DVD R/W device 212 are CD/DVD disks 234 (which can be both read and write-able). Usable with diskette drive device 214 are floppy diskettes 237. Each of the memory storage devices, or the memory storage media (216, 218, 220, 224, 234, and 237, among other types), can contain parts or components, or in its entirety, executable software programming code (software) 236 that can implement part or all of the portions of the method described herein. Further, processor 208 itself can contain one or different types of memory storage devices (most probably, but not in a limiting manner, RAM memory storage media 220) that can store all or some of the components of software 236.

In addition to the above described components, system 200 also comprises user console 234, which can include keyboard 228, display 226, and mouse 230. All of these components are known to those of ordinary skill in the art, and this description includes all known and future variants of these types of devices. Display 226 can be any type of known display or presentation screen, such as liquid crystal displays (LCDs), light emitting diode displays (LEDs), plasma displays, cathode ray tubes (CRTs), among others. User console 235 can include one or more user interface mechanisms such as a mouse, keyboard, microphone, touch pad, touch screen, voice-recognition system, among other inter-active inter-communicative devices.

User console 234, and its components if separately provided, interface with server 201 via server input/output (I/O) interface 222, which can be an RS232, Ethernet, USB or other type of communications port, or can include all or some of these, and further includes any other type of communications means, presently known or further developed. System 200 can further include communications satellite/global positioning system (GPS) transceiver device 238, to which is electrically connected at least one antenna 240 (according to an exemplary embodiment, there would be at least one GPS receive-only antenna, and at least one separate satellite bi-directional communications antenna). System 200 can access internet 242, either through a hard wired connection, via I/O interface 222 directly, or wirelessly via antenna 240, and transceiver 238.

Server 201 can be coupled to other computing devices, such as those that operate or control the equipment of ship 102, via one or more networks. Server 201 may be part of a larger network configuration as in a global area network (GAN) (e.g., internet 242), which ultimately allows connection to various landlines.

According to a further exemplary embodiment, system 700, being designed for use in seismic exploration, will interface with one or more sources 104a,b and one or more receivers 140. These, as previously described, are attached to streamers 106a,b, to which are also attached birds 130a,b that are useful to maintain positioning. As further previously discussed, sources 104 and receivers 140 can communicate with server 201 either through an electrical cable that is part of streamer 106, or via a wireless system that can communicate via antenna 240 and transceiver 238 (collectively described as communications conduit 246).

According to further exemplary embodiments, user console 235 provides a means for personnel to enter commands and configuration into system 200 (e.g., via a keyboard, buttons, switches, touch screen and/or joy stick). Display device 226 can be used to show: streamer 6 position; visual representations of acquired data; source 104 and receiver 140 status information; survey information; and other information important to the seismic data acquisition process. Source and receiver interface unit 202 can receive the hydrophone seismic data from receiver 140 though streamer communication conduit 248 (discussed above) that can be part of streamer 106, as well as streamer 106 position information from birds 130; the link is bi-directional so that commands can also be sent to birds 130 to maintain proper streamer positioning. Source and receiver interface unit 202 can also communicate bi-directionally with sources 104 through the streamer communication conduit 248 that can be part of streamer 106. Excitation signals, control signals, output signals and status information related to source 104 can be exchanged by streamer communication conduit 248 between system 200 and source 104.

Bus 204 allows a data pathway for items such as: the transfer and storage of data that originate from either the source sensors or streamer receivers; for processor 208 to access stored data contained in data storage unit memory 232; for processor 208 to send information for visual display to display 226; or for the user to send commands to system operating programs/software 236 that might reside in either the processor 208 or the source and receiver interface unit 202.

System 200 can be used to implement the methods described above associated with generating a stability indicator according to an embodiment. Hardware, firmware, software or a combination thereof may be used to perform the various steps and operations described herein. According to an embodiment, software 236 for carrying out the above discussed steps can be stored and distributed on multi-media storage devices such as devices 216, 218, 220, 224, 234, and/or 237 (described above) or other form of media capable of portably storing information (e.g., universal serial bus (USB) flash drive 426). These storage media may be inserted into, and read by, devices such as the CD-ROM drive 414, the disk drive 412, among other types of software storage devices.

The disclosed embodiments provide a server node, and a method for generating a stability indicator associated with seismic data. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for monitoring the stability of source directivity between shots, based on an image registration metric of a source signature and generating a stability indicator, said method comprising:
computing a current source directivity cube;
selecting a portion of said current source directivity cube for analysis;
computing a reference directivity cube within said portion;
computing a partitioned intensity uniformity (PIU) metric based on said reference directivity cube and said portion of said source directivity cube;
using said PIU metric to generate said stability indicator; and
outputting said stability indicator.

2. The method of claim 1, wherein said portion is based on criteria comprising a cross-line incidence angle, an azimuth angle and a frequency range.

3. The method of claim 2, wherein said cross-line incidence angle is between negative thirty degrees and thirty degrees, said azimuth angle is between zero degrees and ninety degrees and said frequency range is between one and two hundred Hertz.

4. The method of claim 1, wherein said portion is comprised of a plurality of specific two-dimensional cross-sections.

5. The method of claim 1, wherein said reference directivity cube is associated with a corresponding base shot for a 4D seismic survey.

6. The method of claim 1, wherein said reference directivity cube is partitioned into a plurality of iso-intensity components.

7. The method of claim 6, wherein said plurality of iso-intensity components are mapped to a current imprint.

8. The method of claim 1, wherein said partitioned intensity uniformity (PIU) metric is computed by the equation:
$${\sum }_{b} \frac{{n}_{b}}{N} \frac{{σ}_{b} ( current )}{{μ}_{b} ( current )} ,$$
where N is a total number of pixels in the cube portion, n_{b} is a number of reference pixels within an iso-intensity set b, μ_{b} and σ_{b} are mean and standard deviation measured on the current directivity cube within each mapping b^{T} of set b,

9. The method of claim 8, wherein said mean is computed by the equation:
$$\frac{1}{{n}_{b}} {\sum }_{x ∈ {b}^{T}} A ( x ) .$$

10. The method of claim 9, wherein the square of said standard deviation is computed by the equation:
$$\frac{1}{{n}_{b}} {\sum }_{x ∈ {b}^{T}} {( {A}_{current} ( x ) - {μ}_{b} ( current ) )}^{2} .$$

11. The method of claim 1, wherein said stability indicator is normalized to generate a scalar stability indicator expressed as a percentage.

12. A method for generating a stability indicator, said method comprising:
computing a source directivity cube and a reference directivity cube;
computing a partitioned intensity uniformity (PIU) metric using at least a portion of the source directivity cube and the reference directivity cube;
using said PIU metric to generate said stability indicator; and
outputting said stability indicator.

13. The method of claim 12, wherein computing said reference directivity cube is based on selecting a portion of said source directivity cube for analysis.

14. The method of claim 13, further comprising computing said reference directivity cube within said selected portion.

15. The method of claim 12, wherein said reference directivity cube is associated with a corresponding base shot for a 4D seismic survey.

16. The method of claim 12, wherein said stability indicator is normalized to generate a scalar stability indicator expressed as a percentage.

17. The method of claim 12, wherein said portion is based on criteria comprising a cross-line incidence angle, an azimuth angle and a frequency range.

18. The method of claim 12 wherein said portion is comprised of a plurality of specific two-dimensional cross-sections.

19. The method of claim 12, wherein said stability indicator is based on an image registration metric of a far-field source signature.

20. A system for generating a stability indicator based on an image registration metric of a source signature associated with seismic data, system comprising:
seismic data;
one or more processors configured to execute computer instructions and a memory configured to store said computer instructions wherein said computer instructions further comprise:
a cube component for generating directivity cubes;
a partitioned intensity uniformity (PIU) component for generating a PIU metric based on said directivity cubes;
a stability indicator component for comparing said PIU metric to a predetermined threshold value and generating a stability indicator; and
an output component for outputting said stability indicator.
